(19) United States
(12) Patent Application Publication
(10) Pub. No.: US 2019/0216189 A1
(43) Pub. Date: Jul. 18, 2019

(54) HANDBAG WITH MULTIPLE PROTECTIVE FUNCTIONS

(71) Applicants: Chun-Chung LIU, Taichung City (TW); Cheng-Hui LIU, Taichung City (TW)

(72) Inventors: Chun-Chung LIU, Taichung City (TW); Cheng-Hui LIU, Taichung City (TW)

(21) Appl. No.: 16/015,400

(22) Filed: Jun. 22, 2018

(30) Foreign Application Priority Data
Jan. 17, 2018 (CN) 201810043040.2

(51) Int. Cl. A45C 3/00; A45C 3/06; A45C 13/00; A45C 13/10; B32B 5/02; B32B 5/18; B32B 5/24; B32B 27/06; B32B 27/08; B32B 27/12; B32B 27/30; B32B 27/36

(52) U.S. Cl. CPC A45C 3/001; B32B 2439/46; A45C 13/008; A45C 13/103; B32B 5/024; B32B 5/18; B32B 5/245; B32B 27/065; B32B 27/08; B32B 27/12; B32B 27/306; B32B 27/36; B32B 2250/03; B32B 2250/24; B32B 2250/40; B32B 2262/0284; B32B 2266/0221; B32B 2307/581; B32B 2307/7265; B32B 2307/558; B32B 2307/3065; A45C 3/06

(57) ABSTRACT

A handbag with multiple protective functions includes: a handbag body having front and rear panels and a connection panel connecting the front and rear panels to define a receiving space, wherein a partition layer is disposed in the receiving space to form a plurality of compartments. The connection panel has a plurality of zipper openings disposed at two sides of the partition layer for access into the compartments respectively. Front and rear handles are connected to the front and rear panels, and a shoulder strap having two ends connected to the handbag body. The front and rear panels, the connection panel, the partition layer, the front handle, the rear handle, and the shoulder strap are made of polyester filament yarns fabricated from polyethylene terephthalate so that the handbag has anti-cut, cut-proof, stab-resistant, waterproof, fireproof, and explosion-proof functions.

### CROSS-REFERENCE TO RELATED APPLICATION

This application claims the priority of China patent application No. 201810043040.2, filed on Jan. 17, 2018, which is incorporated herewith by reference.

### BACKGROUND OF THE INVENTION

### 1. Field of the Invention

The present invention relates generally to a protective handbag, and more particularly to a handbag with multiple protective functions such that the multiple protective functions includes cut-proof, slash-proof, stab-resistant, waterproof, fireproof, explosion-proof properties.

### 2. The Prior Arts

Presently, the handbags are generally used to carry personal belongings, or even be served as clothing accessories. Besides these, they do not have other functions. Sometimes, the handbags even become the targets of pickpocketing or bag snatching. When such a sudden dangerous incident happens, the user is often unable to respond in time and to proceed an effective protection. Because the handbag contains important or valuable items, the user may even panic on the first instance. Therefore, the user is discouraged or feels helpless for not able to protect his own life and property safely and effectively.

### SUMMARY OF THE INVENTION

A primary objective according to the present invention is to provide a handbag that can eliminate the abovementioned drawbacks such that the handbag has multiple protective functions, such as cut-proof, stab-resistant, waterproof, fireproof, and explosion-proof properties.

In order to achieve the abovementioned objective, a handbag with multiple protective functions comprises: a handbag body including: a front panel, a rear panel, a connection panel connecting peripheral edges of the front and rear panels to define a receiving space, and a partition layer connected to inner surfaces of the connection panel to partition the receiving space, an upper portion of the connection panel having zipper openings respectively disposed at both sides of the partition layer; a front handle disposed at an upper portion of the front panel; a rear handle disposed at an upper portion of the rear panel; and a shoulder strap having two ends connected to the handbag body, respectively; wherein, the front panel, the rear panel, the connection panel, the partition layer, the front handle, the rear handle, and the shoulder strap are produced by a textile made of polyester filament yarns fabricated from polyethylene terephthalate for security protection.

Preferably, dimethyl terephthalate and ethylene glycol are used as raw materials to produce the polyethylene terephthalate by esterification and polycondensation reaction, the polyethylene terephthalate are processed to produce the fiber filaments to a length of more than 1,000 meters by spinning, and then the fiber filaments are process to produce the polyester filament yarns by filament winding and full stretched yarning.

Preferably, the textile of the front panel, the rear panel, the connection panel, the front handle, the rear handle, and the shoulder strap are manufactured by the polyester filament yarns through a warp-and-weft double strand and double woven method while the textile of the partition layer adopts the polyester filament yarns made of ultra-dense and ultra-fine fibers woven in a large chemical fiber needle staggered manner.

Preferably, the handbag with multiple protective functions according to the present invention further includes a left reception pocket and a right reception pocket that are disposed on an external surface of the front panel and that are manufactured by the same material with the front panel.

Preferably, the handbag with multiple protective functions according to the present invention further includes a rear reception pocket that is disposed on an external surface of the rear panel and that is manufactured by the same material with the rear panel.

Preferably, the handbag with multiple protective functions according to the present invention further includes leather connector elements for connecting the front and rear handles to the handbag body, metal connecting rings provided for connecting the front and rear handle to the leather connector elements and leather handles wrapped around the front and rear handles.

Preferably, the handbag with multiple protective functions according to the present invention further includes a metal triangular ring provided at the leather connector element of the front handle.

Preferably, the handbag with multiple protective functions according to the present invention further includes metal connecting rings respectively provided at two sides of the connection panel and metal buckles respectively provided at two ends of the shoulder strap for engaging with the metal connecting rings.

Preferably, the handbag with multiple protective functions according to the present invention further includes a leather shoulder pad sleeved slidably on the shoulder strap.

Preferably, the handbag with multiple protective functions according to the present invention further includes a front composite shock-absorbing layer and a rear composite shock-absorbing layer respectively disposed on two sides of the partition layer, the front and rear composite shock-absorbing layers including EVA foamed sheets covered by high elastic cloths.

Compared with the prior art, the handbag with multiple protective functions according to the present invention provides the following beneficial effects:

Because the material of the front panel 11, the rear panel 12, the connection panel 13, the partition layer 14, the front handle 2, the rear handle 3, and the shoulder strap 4 are made of a special material, in which the molecules are packed tightly and hence the strength is high with no odor and is easy to clean, excellent anti-cut strength, high tear-and-wear resistance, scratch-and-puncture resistance, acid-and-alkali resistance, nice elasticity and good air permeability, the handbag body can be flexibly used as a defensive tool to resist against tapping, dragging, pulling, hanging, throwing, smashing, and hooking. The handbag with multiple protective functions further possesses good shock absorption and impact prevention effect, so that it has anti-cut, cut-proof, stab-resistant, waterproof, fireproof, and explosion-proof function.

Through the shoulder strap, the front handles, and the rear handles, the handbag body can be flexibly used as a defensive tool to resist against tapping, dragging, pulling, hanging, throwing, smashing, and hooking. It can be used in a wide range of applications. In the case of emergency, the handbag with multiple protective functions according to the present invention can be fully utilized for ones own safety and rescue work.

Since the composite shock-absorbing layers provided on both sides of the partition layer include EVA foamed sheets covered by high elastic cloths, the multifunction handbag according to the present invention has a good shock absorption effect and provides the safety measurements for the users.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a handbag with multiple protective functions according to the present invention;

FIG. 2 is a perspective view showing the handbag with multiple protective functions according to the present invention in another angle; and

FIG. 3 is a schematic view showing a partition layer employed in the handbag with multiple protective functions according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

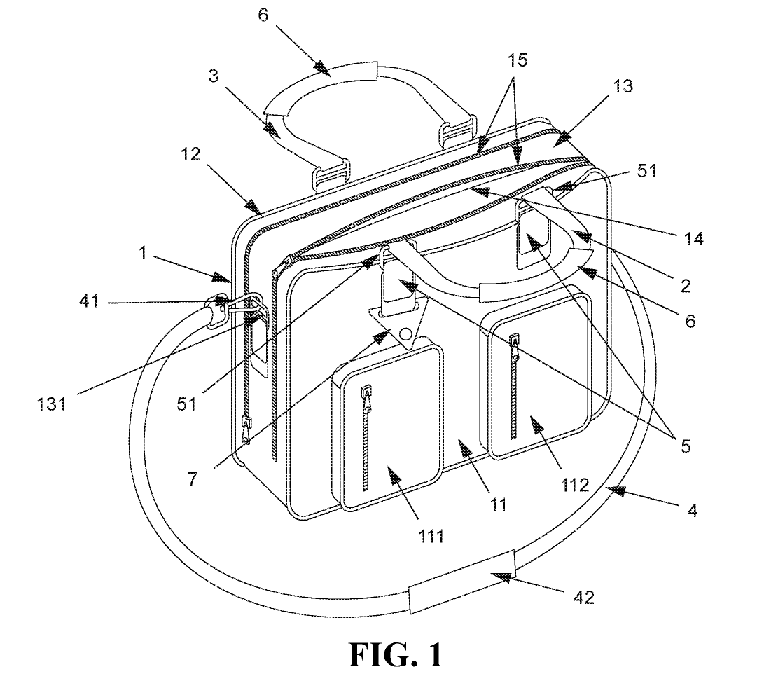

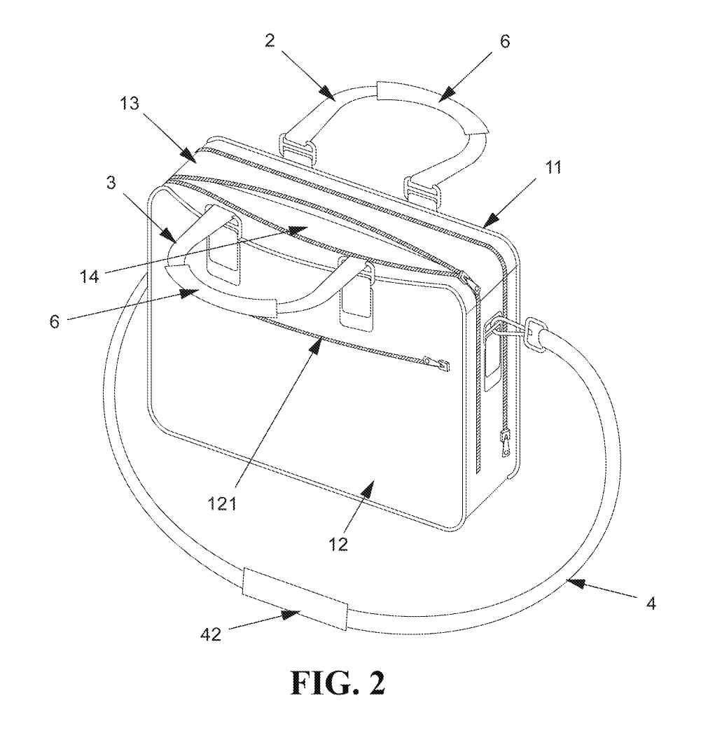

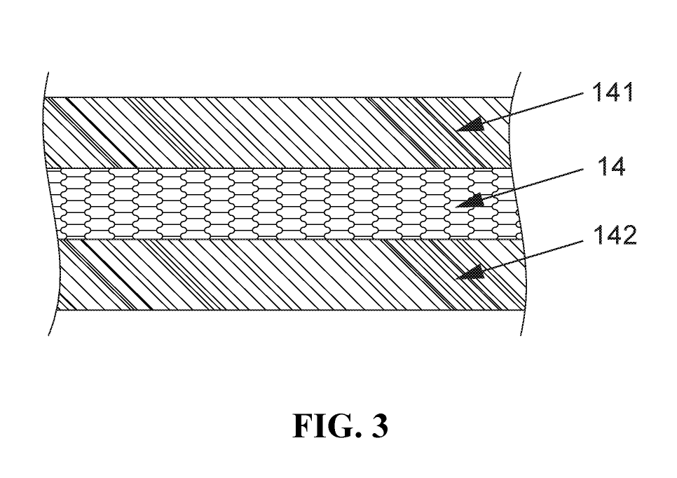

Referring to FIGS. 1-3, wherein FIG. 1 is a perspective view showing a handbag with multiple protective functions according to the present invention; FIG. 2 is a perspective view showing the handbag with multiple protective functions according to the present invention in another angle; and FIG. 3 is a schematic view showing a partition layer employed in the handbag with multiple protective functions according to the present invention. As shown in FIGS. 1-3, a handbag with multiple protective functions according to the present invention includes: a handbag body 1, a front handle 2, a rear handle 3 and a shoulder strap 4.

The handbag body 1 includes a front panel 11, a rear panel 12, a connection panel 13 connecting peripheral edges of the front and rear panels 11 and 12 to define a receiving space, and a partition layer 14 having peripheral edges connected to inner surfaces of the connection panel 13 to partition the receiving space into a plurality of compartments. An upper portion of the connection panel 13 has a plurality of zipper openings 15 disposed at both sides of the partition layer 14 for access into the compartments, respectively.

The front handle 2 is attached to an upper portion of the front panel 11.

The rear handle 3 is attached to an upper portion of the rear panel 12.

The shoulder strap 4 has two ends connected to the handbag body 1, respectively.

The front panel 11, the rear panel 12, the connection panel 13, the partition layer 14, the front handle 2, the rear handle 3, and the shoulder strap 4 are produced by a textile made of polyester filament yarns fabricated from polyethylene terephthalate.

Preferably, dimethyl terephthalate and ethylene glycol are used as raw materials to produce the polyethylene terephthalate by esterification and polycondensation reaction, the polyethylene terephthalate are processed to produce the fiber filaments to a length of more than 1,000 meters by spinning, and then the fiber filaments are process to produce the polyester filament yarns by filament winding and full stretched yarning.

Preferably, the textile of the front panel 11, the rear panel 12, the connection panel 13, the front handle 2, the rear handle 3, and the shoulder strap 4 are manufactured by the polyester filament yarns through a warp-and-weft double strand and double woven method while the textile of the partition layer 14 adopts the polyester filament yarns made of ultra-dense and ultra-fine fibers woven in a large chemical fiber needle staggered manner.

Preferably, the handbag with multiple protective functions according to the present invention further includes a left reception pocket 111 and a right reception pocket 112 that are disposed on an external surface of the front panel 11 and that are manufactured by the same material with the front panel 11.

Preferably, the handbag with multiple protective functions according to the present invention further includes a rear reception pocket 121 that are disposed on an external surface of the rear panel 12 and that are manufactured by the same material with the rear panel 12.

Preferably, the handbag with multiple protective functions according to the present invention further includes leather connector elements 5 for connecting the front and rear handles 2, 3 to the handbag body 1, metal connecting rings 51 provided for connecting the front and rear handle 2, 3 to the leather connector elements 5 and leather handles 6 wrapped around the front and rear handles 2, 3.

Preferably, the handbag with multiple protective functions according to the present invention further includes a metal triangular ring 7 provided on one of the leather connector elements 5, which is connected to the front handle 2 via the metal connecting rings 51.

Preferably, the handbag with multiple protective functions according to the present invention further includes two metal connecting rings 131 respectively provided at two sides of the connection panel 13 and two metal buckles 41 respectively provided at two ends of the shoulder strap 4 for engaging with the metal connecting rings 131.

Preferably, the handbag with multiple protective functions according to the present invention further includes a leather shoulder pad 42 sleeved slidably on the shoulder strap 4.

Preferably, the handbag with multiple protective functions according to the present invention further includes a front composite shock-absorbing layer 141 and a rear composite shock-absorbing layer 142 respectively disposed on two sides of the partition layer 14. The front and rear composite shock-absorbing layers 141, 142 include EVA foamed sheets covered by high elastic cloths.

The using method of the handbag for security protection that is cut-proof, slash-proof, stab-resistant, waterproof, fireproof, explosion-proof according to the present invention includes:

The user takes the handbag for security protection that is cut-proof, slash-proof, stab-resistant, waterproof, fireproof, explosion-proof according to the present invention by holding the leather handles 6 of the front and rear handle 2, 3 with hand or carrying the leather shoulder pad 42 of the shoulder strap 4 with shoulders to make any side of the handbag facing outward. Therefore, the user can use the handbag to block, attack, drag, pull, hang, fling, smash and hook, so as to prevent intrusion of an attacker and protect oneself from dangers.

Because the material of the front panel 11, the rear panel 12, the connection panel 13, the partition layer 14, the front handle 2, the rear handle 3, and the shoulder strap 4 are made of a special material, in which the molecules are packed tightly and hence the strength is high with no odor and is easy to clean, excellent anti-cut strength, excellent toughness, excellent anti-bending, high tear-and-wear resistance, suitable for all weather, scratch-and-puncture resistance, acid-and-alkali resistance, nice elasticity, and good air permeability. The handbag body can be flexibly used as a defensive tool to resist against tapping, dragging, pulling, hanging, throwing, smashing, and hooking. The handbag with multiple protective functions further possesses good shock absorption and impact prevention effect, so that it has anti-cut, cut-proof, stab-resistant, waterproof, fireproof, and explosion-proof function.

It can be used in a wide range of applications. In the case of emergency, the handbag body can be fully utilized for ones own safety and rescue work.

In addition, the partition layer 14 of the handbag is provided with a composite shock-absorbing layers 141, 142, which include EVA foamed sheets covered by high elastic cloths, the device has a good shock absorption effect and provides enhanced safety precautions to the users.

Although the present invention has been described with reference to the preferred embodiments thereof, it is apparent to those skilled in the art that a variety of modifications and changes may be made without departing from the scope according to the present invention which is intended to be defined by the appended claims.

What is claimed is:

1. A handbag with multiple protective functions, comprising:
a handbag body including:
a front panel, a rear panel, a connection panel connecting peripheral edges of the front and rear panels to define a receiving space, and a partition layer having peripheral edges connected to inner surfaces of the connection panel to partition the receiving space into a plurality of compartments, an upper portion of the connection panel having zipper openings respectively disposed at both sides of the partition layer;
a front handle disposed at an upper portion of the front panel;
a rear handle disposed at an upper portion of the rear panel; and
a shoulder strap having two ends connected to the handbag body, respectively;
wherein, the front panel, the rear panel, the connection panel, the partition layer, the front handle, the rear handle, and the shoulder strap are produced by a textile made of polyester filament yarns fabricated from polyethylene terephthalate.

2. The handbag with multiple protective functions according to claim 1, wherein dimethyl terephthalate and ethylene glycol are used as raw materials to produce the polyethylene terephthalate by esterification and polycondensation reaction, the polyethylene terephthalate are processed to produce the fiber filaments to a length of more than 1,000 meters by spinning, and then the fiber filaments are process to produce the polyester filament yarns by filament winding and full stretched yarning.

3. The handbag with multiple protective functions according to claim 1, wherein the textile of the front panel, the rear panel, the connection panel, the front handle, the rear handle, and the shoulder strap are manufactured by the polyester filament yarns through a warp-and-weft double strand and double woven method while the textile of the partition layer adopts the polyester filament yarns made of ultra-dense and ultra-fine fibers woven in a large chemical fiber needle staggered manner.

4. The handbag with multiple protective functions according to claim 2, wherein the textile of the front panel, the rear panel, the connection panel, the front handle, the rear handle, and the shoulder strap are manufactured by the polyester filament yarns through a warp-and-weft double strand and double woven method while the textile of the partition layer adopts the polyester filament yarns made of ultra-dense and ultra-fine fibers woven in a large chemical fiber needle staggered manner.

5. The handbag with multiple protective functions according to claim 1, further comprising a left reception pocket and a right reception pocket that are disposed on an external surface of the front panel and that are manufactured by the same material with the front panel.

6. The handbag with multiple protective functions according to claim 1, further comprising a rear reception pocket that is disposed on an external surface of the rear panel and that is manufactured by the same material with the rear panel.

7. The handbag with multiple protective functions according to claim 1, further comprising leather connector elements for connecting the front and rear handles to the handbag body, metal connecting rings provided for connecting the front and rear handle to the leather connector elements and leather handles wrapped around the front and rear handles.

8. The handbag with multiple protective functions according to claim 7, further comprising a metal triangular ring provided at the leather connector element of the front handle.

9. The handbag with multiple protective functions according to claim 1, further comprising metal connecting rings respectively provided at two sides of the connection panel and metal buckles respectively provided at two ends of the shoulder strap for engaging with the metal connecting rings.

10. The handbag with multiple protective functions according to claim 1, further comprising a leather shoulder pad sleeved slidably on the shoulder strap.

11. The handbag with multiple protective functions according to claim 1, further comprising a front composite shock-absorbing layer and a rear composite shock-absorbing layer respectively disposed on two sides of the partition layer, the front and rear composite shock-absorbing layers including EVA foamed sheets covered by high elastic cloths.
